(19) United States
(12) Patent Application Publication
(10) Pub. No.: US 2023/0199065 A1
(43) Pub. Date: Jun. 22, 2023

(54) RESOURCE SHARING METHOD AND APPARATUS, ELECTRONIC DEVICE AND COMPUTER-READABLE MEDIUM

(71) Applicant: Beijing Bytedance Network Technology Co., Ltd., Beijing (CN)

(72) Inventor: Qin YU, Beijing (CN)

(21) Appl. No.: 17/926,416

(22) PCT Filed: May 18, 2021
(86) PCT No.: PCT/CN2021/094363

§ 371 Date: Nov. 18, 2022

(30) Foreign Application Priority Data
May 20, 2020 (CN) 202010432838.3

(51) Int. Cl. H04L 67/1074; H04W 4/80; H04L 67/63; H04W 4/02

(52) U.S. Cl. CPC H04L 67/1078; H04W 4/80; H04L 67/63; H04W 4/025; H04W 84/02

(57) ABSTRACT

Provided are a resource sharing method and apparatus, an electronic device and a computer-readable medium, which relate to the technical field of information exchange. The method comprises includes: acquiring user information of at least one candidate user; displaying the user information, and receiving a selection operation of a first user for the user information; and determining a second terminal device according to the selection operation, and sending, to the second terminal device and by means of short-distance communication, resources to be shared.

The present application claims priority of Chinese Patent Application No. 202010432838.3 filed on May 20, 2020, the disclosure of which is incorporated herein by reference in its entirety as part of the present application.

### TECHNICAL FIELD

Embodiments of the present disclosure relate to a field of information interaction technologies, and particularly, to a resource sharing method, an apparatus, an electronic device, and a computer-readable medium.

### BACKGROUND

With the development of network technologies, the acquiring of resources by users is becoming more and more convenient, resource sharing among users is becoming more and more popular, and resource sharing has become the theme of the times.

### SUMMARY

In the first aspect, the resource sharing method applied to the first terminal device is provided. The resource sharing method comprises: acquiring user information of at least one candidate user; displaying the user information, and receiving a selecting operation of a first user for the user information; determining a second user according to the selecting operation, and determining a device where the second user is located as a second terminal device; and sending, in the short-distance communication mode, a resource to be shared to the second terminal device. The first terminal device searches, in the short-distance communication mode, a terminal device to which each candidate user belongs.

In the second aspect, the resource sharing method applied to the second terminal device is provided. The resource sharing method comprises: receiving, in a short-distance communication mode, a sending request for a resource to be shared sent by a first user through a first terminal device, and displaying the sending request; receiving an operation instruction of a second user based on the sending request; performing a corresponding operation according to the operation instruction. The first user and the second user are users using a same application.

In the third aspect, a resource sharing apparatus is provided. The apparatus comprises a user information acquiring module, a selecting operation receiving module, a second terminal device determining module, and a resource sharing module. The user information acquiring module is configured to acquire user information of at least one candidate user. The first terminal device searches, in a short-distance communication mode, a terminal device to which each candidate user belongs. The selecting operation receiving module is configured to display the user information, and receive a selecting operation of a first user for the user information. The second terminal device determining module is configured to determine a second user according to the selecting operation, and determine a device where the second user is located as a second terminal device. The resource sharing module is configured to send, in the short-distance communication mode, a resource to be shared to the second terminal device.

In the fourth aspect, a resource sharing apparatus is provided. The apparatus comprises a sending request receiving module, an operation instruction receiving module, and an operation performing module. The sending request receiving module is configured to receive, in a short-distance communication mode, a sending request for a resource to be shared sent by a first user through a first terminal device, and display the sending request. The operation instruction receiving module is configured to receive an operation instruction of a second user based on the sending request, and the first user and the second user are users using a same application. The operation performing module is configured to perform a corresponding operation according to the operation instruction.

In the fifth aspect, an electronic device is provided. The electronic device comprises one or more processors, a memory, and one or more applications. The one or more applications are stored in the memory and configured to be executed by the one or more processors; and the one or more applications are configured to execute the resource sharing method above.

In the sixth aspect, a computer-readable medium is provided. The computer-readable medium stores at least one instruction, at least one program, a code set or an instruction set. The at least one instruction, the at least one program, the code set or the instruction set is loaded and executed by the processor to implement the resource sharing method above.

### BRIEF DESCRIPTION OF THE DRAWINGS

In order to clearly illustrate the technical solution of the embodiments of the present disclosure, the drawings to be used in description of the embodiments will be briefly described in the following.

FIG. 1 is a schematic flow chart of a resource sharing method provided by an embodiment of the present disclosure;

FIG. 2 is a schematic diagram of displaying user information provided by an embodiment of the present disclosure;

FIG. 3 is a schematic diagram of user selection provided by an embodiment of the present disclosure;

FIG. 4 is a schematic diagram of the selection by a single user provided by an embodiment of the present disclosure;

FIG. 5 is a schematic diagram of the selection by a plurality of users provided by an embodiment of the present disclosure;

FIG. 6 is a schematic flow chart of sending a resource to be shared provided by an embodiment of the present disclosure;

FIG. 7 is a schematic flow chart of another resource sharing method provided by an embodiment of the present disclosure;

FIG. 8 is a schematic diagram of displaying a request for a resource to be shared provided by an embodiment of the present disclosure;

FIG. 9 is a schematic flow chart of acquiring user information of the first user provided by an embodiment of the present disclosure;

FIG. 10 is a schematic diagram of displaying user information of the first user provided by an embodiment of the present disclosure;

FIG. 11 is a schematic flow chart of acquiring user information of the third user provided by an embodiment of the present disclosure;

FIG. 12 is a schematic diagram of displaying a homepage of the third user provided by an embodiment of the present disclosure;

FIG. 13 is a structural schematic diagram of a resource sharing apparatus provided by an embodiment of the present disclosure;

FIG. 14 is a structural schematic diagram of another resource sharing apparatus provided by an embodiment of the present disclosure; and

FIG. 15 is a structural schematic diagram of an electronic device provided by an embodiment of the present disclosure.

### DETAILED DESCRIPTION

Embodiments of the present disclosure will be described in more detail below with reference to the accompanying drawings. Although certain embodiments of the present disclosure are illustrated in the accompanying drawings, it should be understood that the present disclosure can be implemented in various forms, and should not be interpreted as limited to the embodiments set forth herein. Instead, these embodiments are provided for a more thorough and complete understanding of the present disclosure. It should be understood that the accompanying drawings and the embodiments of the present disclosure are only for illustrative purposes, and are not intended to limit the protection scope of the present disclosure.

It should be understood that various steps described in the method implementations of the present disclosure may be executed in different orders and/or in parallel. Furthermore, the method implementations may include additional steps and/or omit execution of the steps shown. The scope of the present disclosure will not be limited in this regard.

The term “including” and variants thereof used herein are open including, that is, “including but not limited to”. The term “based on” is “at least partially based on”. The term “one embodiment” represents “at least one embodiment”; the term “another embodiment” represents “at least one other embodiment”; and the term “some embodiments” represents “at least some embodiments”. Relevant definitions of other terms will be given in the following descriptions.

It should be noted that concepts such as “first”, “second” and the like as mentioned in the present disclosure are only used to distinguish apparatuses, modules or units, but not to define that these apparatuses, modules or units must be different apparatuses, modules or units, nor to define orders or interdependence of functions executed by these apparatuses, modules or units.

It should be noted that modifications of “one” and “a plurality of” as mentioned in the present disclosure are exemplary rather than restrictive. Those skilled in the art should understand that unless otherwise explicitly specified in the context, it should be understood as “one or more”.

The names of messages or information interacted between a plurality of apparatuses according to the implementations of the present disclosure are only used for illustrative purposes, and are not used to limit the scope of these messages or information.

In the existing resource sharing technology, when a user wants to share a resource, he/she needs to share the resource based on a relation chain, that is, when the user shares a resource, he/she needs to acquire contact information of the other party, for example, an account, etc., or he/she needs to become a friend of the other party to share the resource, which brings inconvenience to resource sharing, leads to a limited resource sharing scope of the user, and fails to maximize resource utilization, thereby resulting in the waste of resources.

Thus, it may be seen that in the existing resource sharing technology, the user needs to acquire the contact information of the other party or become a friend with the other party to share a resource, which brings inconvenience to resource sharing, limits the scope of resource sharing for the user, and fails to maximize resource utilization, resulting in the waste of resources.

A purpose of the present disclosure is to solve at least one of the above-described technical defects, especially the technical defect that in the existing resource sharing technology, the user needs to acquire the contact information of the other party or become a friend with the other party in order to share a resource, which brings inconvenience to resource sharing, limits the scope of resource sharing for the user, and fails to maximize resource utilization, resulting in waste of resources.

In the embodiments of the present disclosure, the user information of a candidate user is searched in a short-distance communication mode, the second user to whom a resource needs to be shared is determined according to a selecting operation of the user, and the resource to be shared is shared in the short-distance communication mode to a terminal device where the second user is located. The resource may be directly shared to a stranger without a relation chain between users, which expands the scope of resource sharing. In addition, sharing in the short-distance communication mode can save users' traffic.

Hereinafter, the technical solution of the present disclosure and how the technical solution of the present disclosure solves the above-described technical problems will be described in detail below with specific embodiments. The following specific embodiments may be combined with each other, and same or similar concepts or processes may not be repeated in some embodiments. The embodiments of the present disclosure will be described below in combination with the accompanying drawings.

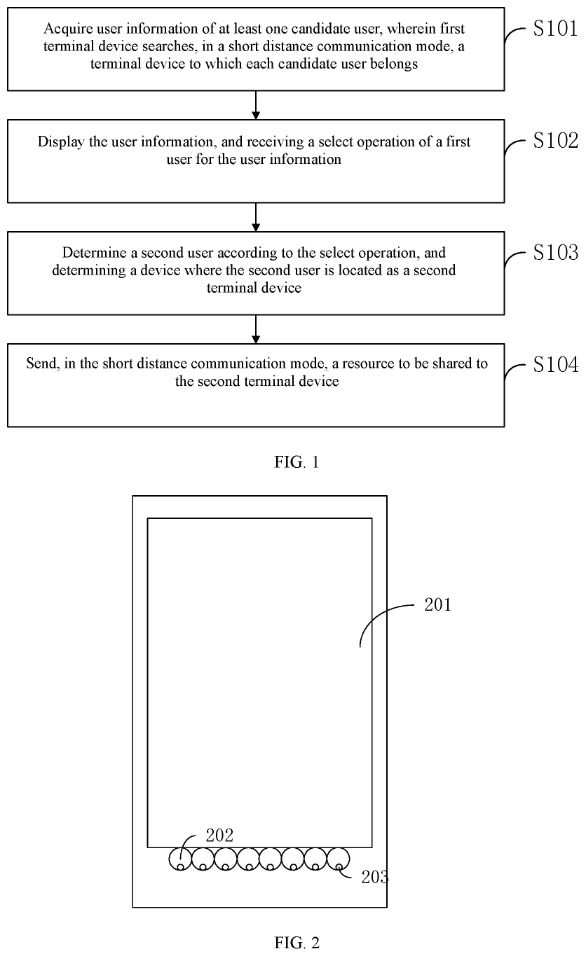

The embodiment of the present disclosure provides a resource sharing method, which is applied to the first terminal device, as illustrated in FIG. 1. The method includes:

Step S101: acquiring user information of at least one candidate user. The first terminal device searches, in a short-distance communication mode, a terminal device to which each candidate user belongs.

Step S102: displaying the user information, and receiving a selecting operation of a first user for the user information.

Step S103: determining a second user according to the selecting operation, and determining a device where the second user is located as the second terminal device;

Step S104: sending, in the short-distance communication mode, a resource to be shared to the second terminal device.

With respect to the embodiment of the present disclosure, the provided resource sharing method may be applied to a mobile phone Application (APP), which is a method based on resource sharing between APP users. The first user and the second user are both users of the APP. The embodiments are illustrated below by taking that the method is applied to the APP as an example, and the first terminal device and the second terminal device are installed with the APP.

In step S101, the user information of at least one candidate user is acquired, and the first terminal device searches, in the short-distance communication mode, a terminal device to which each candidate user belongs.

In the embodiments of the present disclosure, the first terminal device refers to a smart device installed with the above-described APP, for example, a smart phone, a personal tablet computer, a smart watch, etc., which may implement the resource sharing method provided by the present disclosure through the above-described APP. A candidate device is searched by the first terminal device in the short-distance communication mode, and the candidate device is also installed with the APP. The candidate device and the first terminal device may search each other through the APP in the short-distance communication mode.

With respect to the embodiments of the present disclosure, the candidate device and the first terminal device both refer to devices with the function “people nearby” turned on in the APP. after the function “people nearby” is turned on, when the distance between the first terminal device and the candidate device is within a certain range, the first terminal device and the candidate device may search the user information therebetween by distance communication. As an example of the present disclosure, when the user of the first terminal device needs to share a resource, he/she may turn on the functional option “people nearby” and search for user information corresponding to at least one candidate device. Of course, “people nearby” is only a term chosen for convenience of description in the present disclosure, and those skilled in the art may also use other terms to define, for example, “users nearby”, etc., which are not limited in the present disclosure.

In step S102, the user information is displayed, and the selecting operation of the first user for the user information is received.

In the embodiments of the present disclosure, the first user refers to a user of the first terminal device. The first terminal device is provided with a displaying apparatus, which may display the user information in the preceding steps, and may receive the selecting operation of the first user.

With respect to the embodiments of the present disclosure, after searching out the user information of at least one candidate user, the first terminal device displays the user information, as illustrated in FIG. 2, which is a schematic diagram of displaying the user information. The displayed content 201 is the content being displayed by the first terminal device, and the user information 202 is a display region of the user information of the first authorized user, and the user information may be displayed through the region, including but not limited to, user's avatar, name, and etc. A selecting operation region 203 refers to a region through which the first user may select the user information. The position arrangement of the displayed content 201, the user information 202, and the selecting operation region 203 may be designed by those skilled in the art when implementing the present disclosure, which is not limited in the present disclosure.

In step S103, the second user is determined according to the selecting operation, and the device where the second user is located is determined as the second terminal device.

In the embodiments of the present disclosure, the user's selecting operation refers to an operation that the first user determines which user information is that of the second user, and is an operation based on the selecting operation region 203 according to the above-described embodiments.

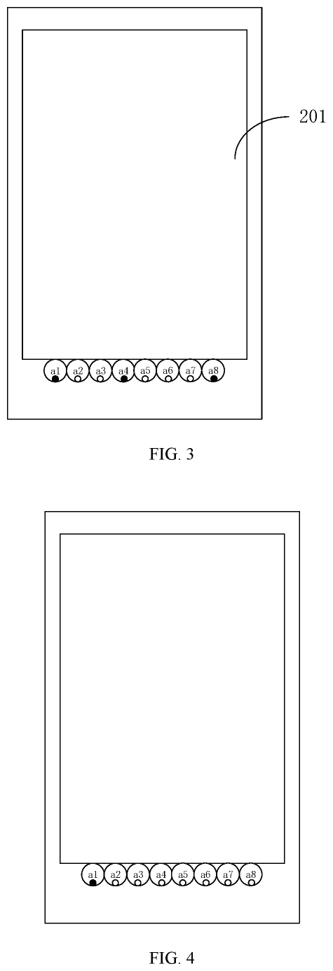

In the embodiments of the present disclosure, for convenience of explanation, taking the above-described embodiment as an example, as illustrated in FIG. 3, the first terminal device searches 8 candidate devices, whose corresponding users are respectively a1, a2, a3, . . . , and a8, the user information of the above-described 8 users are respectively displayed on the first terminal device, and the user performs the selecting operation for the user information of the 8 users. The selecting operation may be clicking a selecting operation region corresponding to the user information, and as illustrated in FIG. 3, if the first user determines users a1, a4 and a8 as the second users, then the marks representing that the users are selected, for example, filled by pure color, are displayed in the selecting operation region of the second user. Meanwhile, the terminal devices where the users a1, a4, and a8 are located are determined as the second terminal devices.

In step S104, the resource to be shared is sent to the second terminal device in the short-distance communication mode.

In the embodiments of the present disclosure, the resource to be shared refer to the resource that the first user wants to share through the APP in the first terminal device, for example, a video resource, a picture resource, an audio resource, and etc.

With respect to the embodiments of the present disclosure, after the second terminal device is determined, the resource to be shared is sent to the second terminal device in the short-distance communication mode. The short-distance communication mode includes but is not limited to a WiFi point-to-point communication mode and a Bluetooth communication mode. As an example of the present disclosure, the resource to be shared may be sent to the second terminal device in the WiFi point-to-point direct connection mode, or the resource to be shared may be sent to the second terminal device in the Bluetooth communication mode.

In the embodiments of the present disclosure, the user information of a candidate device is searched in the short-distance communication mode, the second user to whom the resource needs to be shared is determined according to the user's selecting operation, and the resource to be shared is shared in the short-distance communication mode to the terminal device where the second user is located. The resource may be directly shared to a stranger without a relation chain between users, which expands the scope of resource sharing, and in addition, sharing in the short-distance communication mode can save users' traffic.

The embodiments of the present disclosure provide a possible implementation. In the resource sharing method provided by the present disclosure, the short-distance communication mode includes: the Bluetooth communication mode and/or the WiFi point-to-point communication mode.

In the embodiments of the present disclosure, the short-distance communication mode refers to the communication mode in a short distance without traffic, including but not limited to, the Bluetooth communication mode and the WiFi point-to-point communication mode. As an embodiment of the present disclosure, when searching for the candidate device, the first terminal device may choose to search in the Bluetooth communication mode or in the WiFi point-to-point communication mode. When sending the resource to be shared to the second terminal device, the Bluetooth communication mode or the WiFi point-to-point communication mode may be chosen.

In the embodiments of the present disclosure, the candidate device is searched and the resource to be shared is sent to the second terminal device in the Bluetooth communication mode and/or in the WiFi point-to-point communication mode, without consuming traffic of the user, which saves traffic.

The embodiments of the present disclosure provide a possible implementation. In the implementation, in the resource sharing mode provided by the present disclosure, the determining the second user according to the selecting operation, includes:

Determining one and/or more candidate users as the second user according to the selecting operation.

In the embodiments of the present disclosure, the second user refers to the user to whom the first user wants to share the resource to be shared. The second user(s) may be one or more users.

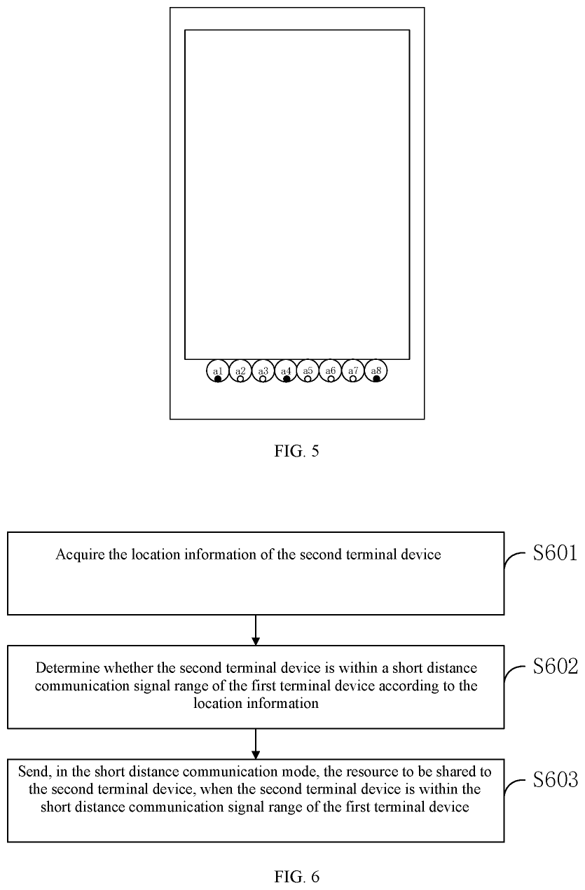

With respect to the embodiments of the present disclosure, for convenience of illustration, it is illustrated by taking the above-described embodiments as an example. The first terminal device determines one and/or more the second users according to the user's selecting operation received, as illustrated in FIG. 4. When the user's selecting operation only includes the selection for the user information of one user, the one user is determined as the second user. For example, the user al is determined as the second user, as illustrated in FIG. 5. When the user's selecting operation includes the selection for the user information of a plurality of users, the plurality of users are determined as the second users, for example, the users a1, a4, and a8 are determined as the second users.

In the embodiments of the present disclosure, the user may determine one and/or more users as the second user(s) through the selecting operation, which facilitates the user to share a resource with the one or more users at a same time, which has a wide scope of application.

The embodiments of the present disclosure provide a possible implementation. In the implementation, as illustrated in FIG. 6, in the resource sharing method provided by the embodiments of the present disclosure, the sending the resource to be shared to the second terminal device, includes:

Step S601: acquiring the location information of the second terminal device.

In the embodiments of the present disclosure, the location information of the second terminal device refers to the geographic location information where the second device terminal is located. The acquiring of the location information of the second terminal device may be the acquiring of IP address information of the second terminal device, or may also be the acquiring of GPS location information of the second terminal device, which is not be limited in the present disclosure.

Step S602: determining whether the second terminal device is within a short-distance communication signal range of the first terminal device according to the location information.

In the embodiments of the present disclosure, after the location information of the second terminal device is acquired, it is determined whether the second terminal is within a Bluetooth signal range of the first terminal device according to the location information. The short-distance communication mode includes: the Bluetooth communication mode and/or the WiFi point-to-point communication mode. As an embodiment of the present disclosure, whether the second terminal is within the Bluetooth signal range of the first terminal device may be determine through a contacting test, to determine whether there is a normal communication with the second terminal device in the short-distance communication mode. The contacting test is a conventional technology in the art, which is not repeated here in the present disclosure.

Step S603: sending, in the short-distance communication mode, the resource to be shared to the second terminal device, when the second terminal device is within the short-distance communication signal range of the first terminal device.

In the embodiments of the present disclosure, when the second terminal device is within the short-distance communication signal range of the first terminal device, the resource to be shared is sent to the second terminal device in the short-distance communication mode. The short-distance communication mode includes: the Bluetooth communication mode and/or the WiFi point-to-point communication mode.

In the embodiments of the present disclosure, the location information of the second terminal device is acquired, and whether the short-distance communication can be carried out with the second terminal device is determined according to the location information, to ensure normal progress of resource sharing.

The embodiments of the present disclosure provides a possible implementation. In the implementation, the sending the resource to be shared to the second terminal device, includes: acquiring the internet protocol IP address information of the second terminal device; determining whether the second terminal device and the first terminal device are located in the same WiFi environment according to the internet protocol IP address information; and sending, in the WiFi communication mode, the resource to be shared to the second terminal device, when the second terminal device and the first terminal device are located in the same WiFi environment.

In the embodiments of the present disclosure, before sending the resource to be shared to the second terminal device, it is necessary to verify the second terminal device. By acquiring the IP address information of the second terminal device, it is determined whether the second terminal device and the first terminal device are located in the same WiFi environment according to the IP address information. When the second terminal device and the first terminal device are located in the same WiFi environment, the resource to be shared is sent to the second terminal device in the WiFi communication mode.

In the embodiments of the present disclosure, the second terminal device is verified through the IP address, to ensure that the second terminal device and the first terminal device are located in the same WiFi environment, and the resource to be shared is directly sent to the second terminal device through the WiFi, which saves traffic.

The embodiments of the present disclosure provide a possible implementation. In the implementation, the sending the resource to be shared to the second terminal device, includes: acquiring the internet protocol IP address information of the second terminal device; determining whether the second terminal device is within the Bluetooth signal range of the first terminal device according to the internet protocol IP address information; and sending, in the Bluetooth communication mode, the resource to be shared to the second terminal device, when the second terminal device is within the Bluetooth signal range of the first terminal device.

In the embodiments of the present disclosure, before sending the resource to be shared to the second terminal device, it is necessary to verify the second terminal device. By acquiring the IP address information of the second terminal device, it is determined whether the second terminal device is within the Bluetooth signal range of the first terminal device according to the IP address information. When the second terminal device is within the Bluetooth range of the first terminal device, the resource to be shared is sent to the second terminal device in the Bluetooth communication mode.

In the embodiments of the present disclosure, the second terminal device is verified through the IP address, to ensure that the second terminal device is within the

Bluetooth signal range of the first terminal device, and the resource to be shared is directly sent to the second terminal device in the Bluetooth communication mode, which saves traffic.

In the embodiments of the present disclosure, the user information of a candidate device is searched for in the short-distance communication mode, the second user to whom the resource needs to be shared is determined according to the user's selecting operation, and the resource to be shared is shared to the terminal device where the second user is located in the short-distance communication mode. The resource may be directly shared to a stranger without a relation chain between users, which expands the scope of resource sharing. In addition, sharing in the short-distance communication mode can save users' traffic.

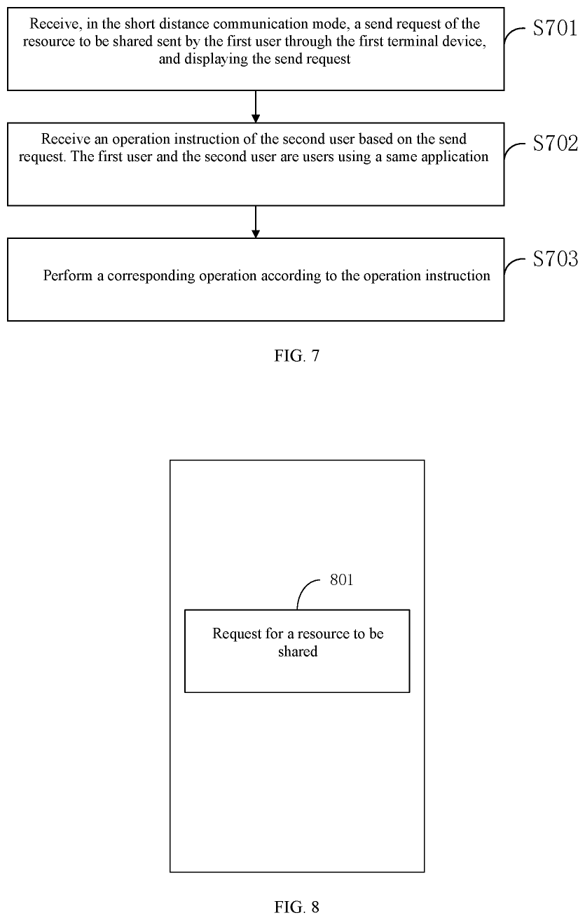

The implementation of the present disclosure provides a resource sharing method, which is applied to the second terminal device according to the above-described embodiment, as illustrated in FIG. 7. The method includes:

Step S701: receiving a sending request of the resource to be shared sent by the first user through the first terminal device in the short-distance communication mode, and displaying the sending request.

Step S702: receiving an operation instruction of the second user based on the sending request. The first user and the second user are users using the same application.

Step S703: performing a corresponding operation according to the operation instruction.

In the embodiments of the present disclosure, the second terminal device refers to the device where the second user is located, and the resource sharing method provided by the embodiments of the present disclosure is applied to the second terminal device.

In step S701, the sending request of the resource to be shared sent by the first user through the first terminal device is received in the short-distance communication mode, and the sending request is displayed.

In the embodiments of the present disclosure, after the first terminal device sends the resource to be shared to the second terminal device in the short-distance communication mode, the second terminal device receives the sending request and displays the sending request. As illustrated in FIG. 8, a request for the resource to be shared 801 is displayed on a display interface of the second terminal device.

In step S702, the operation instruction of the second user based on the sending request is received. The first user and the second user are users using the same application.

In the embodiments of the present disclosure, when displaying the sending request, the second terminal device receives the operation instruction of the second user based on the sending request. The second user refers to a user of the second terminal device, and the operation instruction refers to an operation instruction for the sending request, for example, receiving the resource to be shared, rejecting the resource to be shared, and etc.

In step S703, the corresponding operation is performed according to the operation instruction.

In the embodiments of the present disclosure, the second terminal device performs the operation corresponding to the operation instruction according to the type of the operation instruction. For example, when the operation instruction is to receive the resource to be shared, the second terminal device receives the resource to be shared. When the operation instruction is to reject the resource to be shared, the second terminal device rejects the resource to be shared.

In the embodiments of the present disclosure, the sending request of the first terminal device is displayed, the operation instruction of the second user based on the sending request is received, and the corresponding operation is performed according to the operation instruction, so as to ensure that the operation is performed at the will of the user.

The embodiments of the present disclosure provide a possible implementation. In the implementation, the operation instruction includes a receiving instruction. The performing a corresponding operation according to the operation instruction, includes: receiving the resource to be shared in the short-distance communication mode.

In the embodiments of the present disclosure, in the case where the operation instruction of the second user is a receiving instruction, the resource to be shared is received in the short-distance communication mode. The short-distance communication mode includes: the Bluetooth communication mode and/or the WiFi point-to-point communication mode.

In the embodiments of the present disclosure, the resource to be shared is received in the short-distance communication mode according to a receiving instruction of the second user, which ensures that the resource to be shared is received at the will of the second user, and the resource to be shared is received in the short-distance communication mode, which saves traffic.

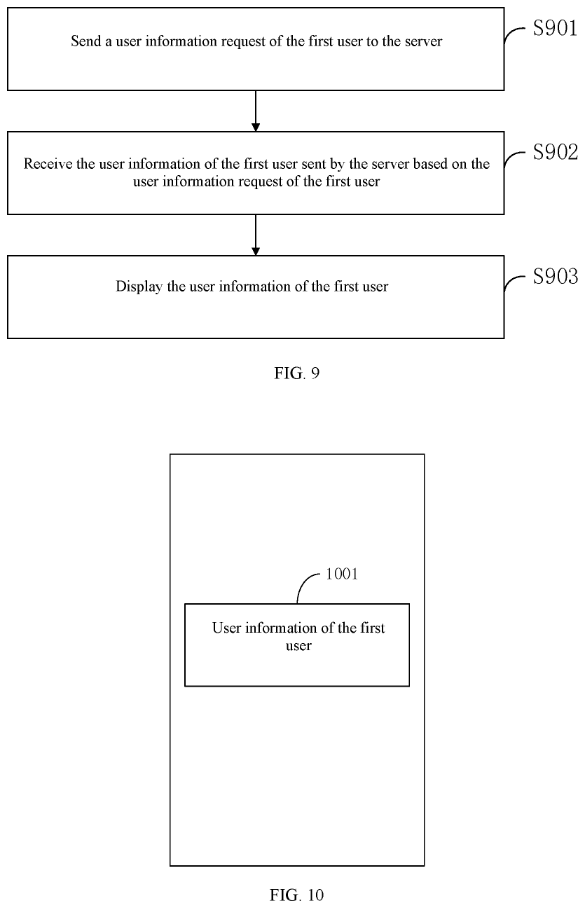

The embodiments of the present disclosure provides a possible implementation. In the implementation, the operation instruction includes acquiring the user information of the first user, and as illustrated in FIG. 9, the receiving the corresponding operation according to the operation instruction, includes:

Step S901: sending a user information acquiring request of the first user to the server.

In the embodiments of the present disclosure, the second terminal device may communicate through a server. When the operation instruction of the second user includes acquiring the user information of the first user, the second terminal device sends the user information request of the first user to the server.

Step S902: receiving the user information of the first user sent by the server based on the user information acquiring request of the first user.

In the embodiments of the present disclosure, after the user information acquiring request of the first user is sent to the server, the user information of the first user sent by the server based on the user information request of the first user is received. The user information may include avatar information, name information, authentication information of the first user.

Step S903: displaying the user information of the first user.

In the embodiments of the present disclosure, after the user information of the first user sent by the server is received, the user information of the first user is displayed, and as illustrated in FIG. 10, the user information 1001 of the first user is displayed on the display interface of the second terminal device.

In the embodiments of the present disclosure, the second user may send the user information acquiring request of the first user to the server through the second terminal device according to the sending request of the first user, acquire the user information of the first user, and determine whether to receive the resource to be shared sent by the first user.

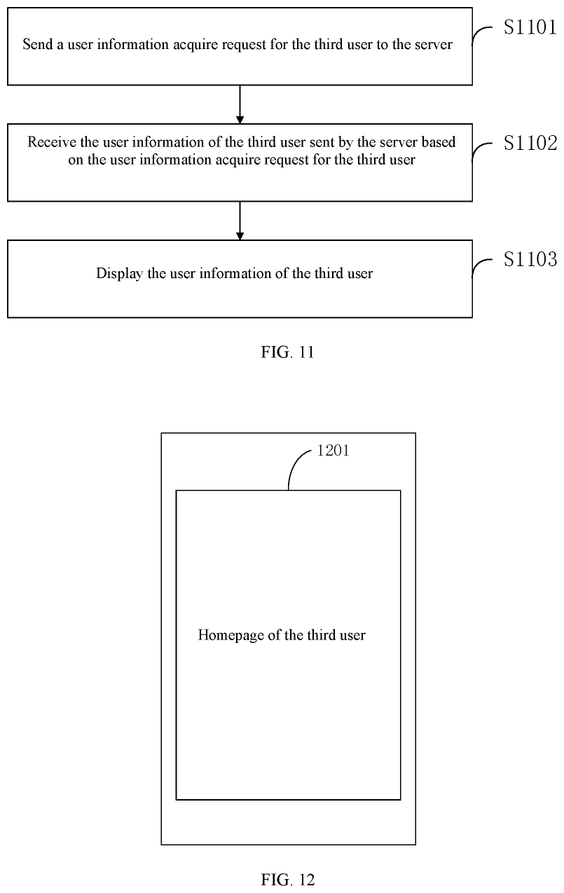

The embodiments of the present disclosure provide a possible implementation. In the implementation, the operation instruction includes acquiring the user information of the third user. The third user is the user who uploads the resource to be shared to the application. As illustrated in FIG. 11, the executing the corresponding operation according to the operation instruction, includes:

Step S1101: sending a user information acquiring request for the third user to the server.

In the embodiments of the present disclosure, when the operation instruction of the second user includes an instruction to acquire the user information of the third user, a user information acquiring request of the third user is sent to the server. The third user is the user who uploads the resource to be shared to the application, and the third user may also be the first user and/or the second user. As an embodiment of the present disclosure, when the third user is the first user, if the first user wants to promote his/her works after uploading the same to the application, he/she may promote the works to the second user who is nearby but not his/her friend by using the resource sharing method provided by the present disclosure, so that the second user may directly view the first user's homepage, facilitating other users to learn more the works of the first user, which has better promotion effects for the first user. As another embodiment of the present disclosure, when the third user is the second user, if the first user finds that an author of certain works is a just user nearby when viewing the works, the first user may share the works to the author of the works by using the resource sharing method provided by the present disclosure, so as to improve the interaction between the user and the author.

Step S1102: receiving the user information of the third user sent by the server based on the user information acquiring request for the third user.

In the embodiments of the present disclosure, after the second terminal device sends the user information acquiring request for the third user to the server, the user information of the third user sent by the server based on the user information acquiring request for the third user is received.

Step S1103: displaying the user information of the third user.

In the embodiments of the present disclosure, the user information of the third user is displayed on the display interface of the second terminal device.

The embodiments of the present disclosure provide a possible implementation. In the implementation, the displaying the user information of the third user, includes: jumping to and displaying the homepage of the third user.

In the embodiments of the present disclosure, the displaying the user information of the third user may be jumping to the homepage of the third user and displaying the homepage of the third user, as illustrated in FIG. 12, the homepage of the third user 1201 is displayed on the presentation interface of the second terminal device.

In the embodiments of the present disclosure, by displaying the homepage of the third user, the second user may directly learn information of the uploader of the resource to be shared, so as to facilitate sharing and spreading of the resource to be shared.

The embodiments of the present disclosure provide a possible implementation. In the implementation, the operation instruction includes a rejecting instruction, and the performing the corresponding operation according to the operation instruction, includes: rejecting the reception of the resource to be shared.

In the embodiments of the present disclosure, when the operation instruction of the second user is a rejecting instruction, the user rejects to receive the resource to be shared.

In the embodiments of the present disclosure, the user may choose to reject receiving the resource sent by the first user, thereby giving the user more choices.

The embodiments of the present disclosure provides a possible implementation. In the implementation, the operation instruction includes a blacklisting instruction, and the performing a corresponding operation according to the operation instruction, includes: adding the first user to the blacklist, so that the user of the second terminal device cannot send any resource to the first user in the short-distance communication mode.

In the embodiments of the present disclosure, when the operation instruction of the second user includes a blacklisting instruction, the first user is added to the blacklist so that the user of the second terminal device cannot send any resource to the first user in the short-distance communication mode.

In the embodiments of the present disclosure, the second user may blacklist the first user, which prevents the first user from harassing the second user, ensuring good user experience.

In the embodiments of the present disclosure, user information of a candidate device is searched for in the short-distance communication mode, the second user to whom the resource needs to be shared is determined according to the user's selecting operation, and the resource to be shared is shared in the short-distance communication mode to the terminal device where the second user is located. The resource may be directly shared to a stranger without a relation chain between users, which expands the scope of resource sharing, and in addition, sharing in the short-distance communication mode can save users' traffic.

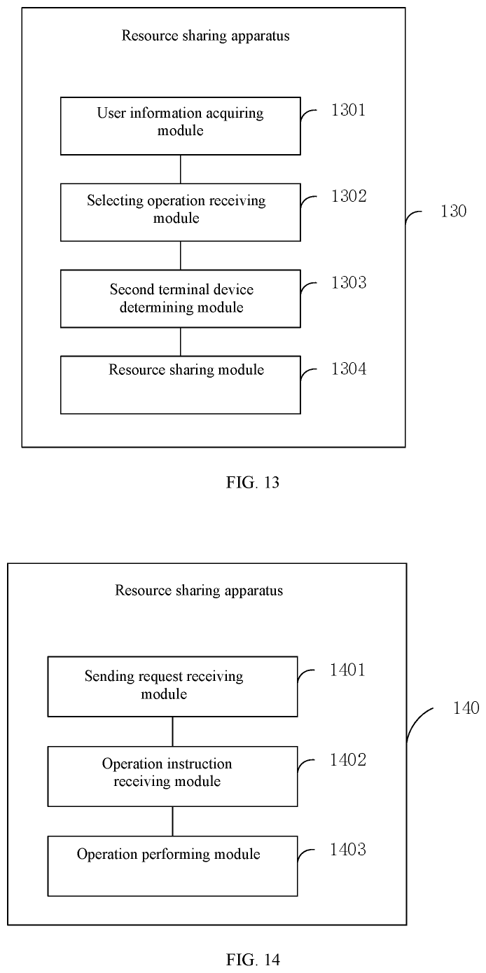

The embodiments of the present disclosure provide a resource sharing apparatus, and as illustrated in FIG. 13. The resource sharing apparatus 130 may include: a user information acquiring module 1301, a selecting operation receiving module 1302, a second terminal device determining module 1303, and a resource sharing module 1304.

The user information acquiring module is configured to acquire user information of at least one candidate user. The first terminal device searches, in the short distance communication mode, a terminal device to which each candidate user belongs.

The selecting operation receiving module is configured to display the user information, and receive a selecting operation of the first user for the user information.

The second terminal device determining module is configured to determine the second user according to the selecting operation, and determine a device where the second user is located as the second terminal device.

The resource sharing module is configured to send, in the short-distance communication mode, a resource to be shared to the second terminal device.

Optionally, the second terminal device determining module provided by the embodiments of the present disclosure may be configured to determine one and/or more candidate users as the second user(s) according to the selecting operation.

Optionally, the resource sharing module provided by the embodiments of the present disclosure, when sending the resource to be shared to the second terminal device, may be configured to: acquire the location information of the second terminal device, determine whether the second terminal device is within a short-distance communication signal range of the first terminal device according to the location information, and send, in the short distance communication mode, the resource to be shared to the second terminal device, when the second terminal device is within the Bluetooth signal range of the first terminal device.

Optionally, the resource sharing module provided by the embodiments of the present disclosure, when sending the resource to be shared to the second terminal device, may be configured to: acquire the internet protocol IP address information of the second terminal device, determine whether the second terminal device and the first terminal device are located in the same WiFi environment according to the Internet protocol IP address information, and send, in the WiFi communication mode, the resource to be shared to the second terminal device, when the second terminal device and the first terminal device are located in the same WiFi environment.

Optionally, the resource sharing module provided by the embodiments of the present disclosure, when sending the resource to be shared to the second terminal device, may be configured to: acquire the internet protocol IP address information of the second terminal device; determine whether the second terminal device is within the Bluetooth signal range of the first terminal device according to the Internet protocol IP address information, and send, in the Bluetooth communication mode, the resource to be shared to the second terminal device, when the second terminal device is within the Bluetooth signal range of the first terminal device.

The embodiments of the present disclosure further provide a resource sharing apparatus. As illustrated in FIG. 14, the apparatus 140 includes a sending request receiving module 1401, an operation instruction receiving module 1402, and an operation performing module 1403.

The sending request receiving module is configured to receive, in the short-distance communication mode, a sending request of the resource to be shared sent by the first user through the first terminal device, and display the sending request.

The operation instruction receiving module is configured to receive an operation instruction of the second user based on the sending request, and the first user and the second user are users using the same application.

The operation performing module is configured to perform the corresponding operation according to the operation instruction.

Optionally, in the case where the operation instruction includes acquiring the user information of the first user, the operation performing module provided by the embodiments of the present disclosure, when performing the corresponding operation according to the operation instruction, may be configured to: send a user information request of the first user to the server, receive the user information of the first user sent by the server based on the user information request of the first user, and display the user information of the first user.

Optionally, in the case where the operation instruction includes acquiring the user information of a third user, the operation performing module provided by the embodiment of the present disclosure, when performing the corresponding operation according to the operation instruction, may be configured to: send a user information acquiring request of the third user to the server, receive the user information of the third user sent by the server based on the user information acquiring request of the third user, and display the user information of the third user.

Optionally, in the case where the operation instruction includes acquiring the user information of the third user, the operation performing module provided by the embodiment of the present disclosure, when performing the corresponding operation according to the operation instruction, may further be configured to: jump to and display a homepage of the third user.

The resource sharing apparatus according to the embodiments of the present disclosure may perform the resource sharing method illustrated in the foregoing embodiments of the present disclosure, implementation principles thereof are similar thereto, which are not repeated here.

In the embodiments of the present disclosure, the user information of a candidate device is searched for in the short-distance communication mode, the second user to whom the resource needs to be shared is determined according to the user's selecting operation, and the resource to be shared is shared in the short distance communication mode to the terminal device where the second user is located. The resource may be directly shared to a stranger without a relation chain between users, which expands the scope of resource sharing, and in addition, sharing in the short-distance communication mode can save users' traffic.

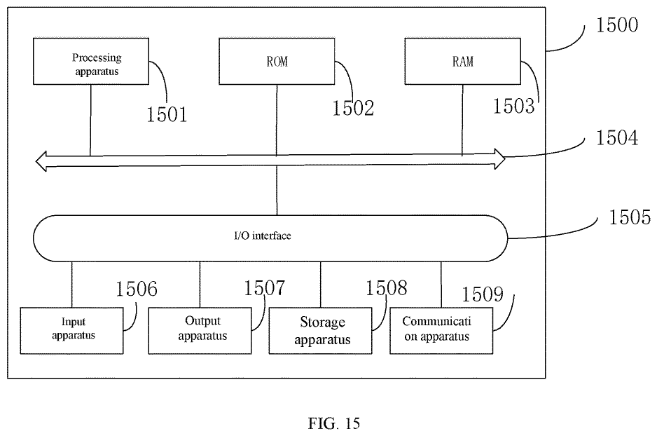

Referring to FIG. 15 below, it shows a structural schematic diagram of an electronic device 1500 suitable for implementing the embodiments of the present disclosure. The electronic device according to the embodiments of the present disclosure may include, but not limited to, a mobile terminal such as a mobile phone, a laptop, a digital broadcast receiver, a Personal Digital Assistant (PDA), a Portable Android Device (PAD), a Portable Multimedia Player (PMP), a vehicle-mounted terminal (e.g., a vehicle-mounted navigation terminal), etc., and a stationary terminal such as a digital TV, a desktop computer, etc. The electronic device illustrated in FIG. 15 is only an example, and should not impose any limitation on the function and use scope of the embodiments of the present disclosure.

The electronic device includes a memory and a processor; wherein, the processor here may be referred to as a processing apparatus 1501 below, and the memory may include at least one of a Read-Only Memory (ROM) 1502, a Random Access Memory (RAM) 1503, and a storage apparatus 1508, specifically as shown below:

As illustrated in FIG. 15, the electronic device 1500 may include a processing apparatus 1501 (e.g., a central processing unit, a graphics processing unit, etc.), which can perform various suitable actions and processing according to a program stored in a read-only memory (ROM) 1502 or a program loaded from a storage apparatus 1508 into a random-access memory (RAM) 1503. The RAM 1503 further stores various programs and data required for operations of the electronic device 1500. The processing apparatus 1501, the ROM 1502, and the RAM 1503 are interconnected by means of a bus 1504. An input/output (I/O) interface 1505 is also connected to the bus 1504.

Usually, the following apparatus may be connected to the I/O interface 1505: an input apparatus 1506 including, for example, a touch screen, a touch pad, a keyboard, a mouse, a camera, a microphone, an accelerometer, a gyroscope, or the like; an output apparatus 1507 including, for example, a liquid crystal display (LCD), a loudspeaker, a vibrator, or the like; a storage apparatus 1508 including, for example, a magnetic tape, a hard disk, or the like; and a communication apparatus 1509. The communication apparatus 1509 may allow the electronic device 1500 to be in wireless or wired communication with other devices to exchange data. While FIG. 15 illustrates the electronic device 1500 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 1509 and installed, or may be installed from the storage apparatus 1508, or may be installed from the ROM 1502. When the computer program is executed by the processing apparatus 1501, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) or the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future. The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: acquire the user information of at least one candidate user, display the user information, and receive a selecting operation of a first user for the user information, determine the second user according to the selecting operation, and determine a device where the second user is located as a second terminal device; and send, in the short-distance communication mode, a resource to be shared to the second terminal device. The first terminal device searches, in a short-distance communication mode, a terminal device to which each candidate user belongs.

The computer program codes for performing the operations of the present disclosure may be written in one or more programming languages or a combination thereof. The above-mentioned programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, a resource sharing method is provided. The method includes:

acquiring user information of at least one candidate user. The first terminal device searches, in a short-distance communication mode, a terminal device to which each candidate user belongs;

displaying the user information, and receiving a selecting operation of a first user for the user information;

determining a second user according to the selecting operation, and determining a device where the second user is located as a second terminal device; and

sending, in the short-distance communication mode, a resource to be shared to the second terminal device.

Further, the determining the second user according to the selecting operation, includes:

determining one and/or more candidate users as the second user(s) according to the selecting operation.

Further, the sending the resource to be shared to the second terminal device, comprises:

acquiring location information of the second terminal device;

determining whether the second terminal device is within a short-distance communication signal range of the first terminal device according to the location information; and

sending, in the short-distance communication mode, the resource to be shared to the second terminal device, when the second terminal device is within the short distance communication signal range of the first terminal device. The short-distance communication signal comprises a Bluetooth signal.

Further, the sending the resource to be shared to the second terminal device, comprises:

acquiring internet protocol IP address information of the second terminal device;

determining whether the second terminal device and the first terminal device are located in a same WiFi environment according to the internet protocol IP address information; and

sending, in a WiFi communication mode, the resource to be shared to the second terminal device, when the second terminal device and the first terminal device are located in the same WiFi environment.

Further, the sending the resource to be shared to the second terminal device, comprises:

acquiring internet protocol IP address information of the second terminal device;

determining whether the second terminal device is within a Bluetooth signal range of the first terminal device according to the internet protocol IP address information; and

sending, in a Bluetooth communication mode, the resource to be shared to the second terminal device, when the second terminal device is within the Bluetooth signal range of the first terminal device.

According to one or more embodiments of the present disclosure, a resource sharing method is provided. The method includes:

receiving, in a short-distance communication mode, a sending request for a resource to be shared sent by a first user through a first terminal device, and displaying the sending request;

receiving an operation instruction of a second user based on the sending request, wherein the first user and the second user are users using a same application;

performing a corresponding operation according to the operation instruction.

Further, the operation instruction comprises acquiring user information of the first user, and the performing the corresponding operation according to the operation instruction, comprises:

sending a user information acquiring request for the first user to a server;

receiving the user information of the first user sent by the server based on the user information acquiring request for the first user; and

displaying the user information of the first user.

Further, the operation instruction comprises acquiring user information of a third user, the third user is a user who uploads the resource to be shared to the application, and the performing the corresponding operation according to the operation instruction, comprises:

sending a user information acquiring request for the third user to a server;

receiving the user information of the third user sent by the server based on the user information acquiring request for the third user; and

displaying the user information of the third user.

Further, the displaying the user information of the third user, comprises:

jumping to and displaying a homepage of the third user.

According to one or more embodiments of the present disclosure, a resource sharing apparatus is provided. The apparatus includes:

a user information acquiring module, configured to acquire user information of at least one candidate user; wherein a first terminal device searches, in a short-distance communication mode, a terminal device to which each candidate user belongs;

a selecting operation receiving module, configured to display the user information, and receive a selecting operation of a first user for the user information;

a second terminal device determining module, configured to determine a second user according to the selecting operation, and determine a device where the second user is located as a second terminal device;

a resource sharing module, configured to send, in the short-distance communication mode, a resource to be shared to the second terminal device.

Optionally, the second terminal device determining module provided by the embodiments of the present disclosure may be configured to:

determine one and/or more candidate users as the second user(s) according to the selecting operation.

Optionally, the resource sharing module provided by the embodiments of the present disclosure, when sending the resource to be shared to the second terminal device, may be configured to:

acquire the location information of the second terminal device,

determine whether the second terminal device is within a short-distance communication signal range of the first terminal device according to the location information, and

send, in the short distance communication mode, the resource to be shared to the second terminal device, when the second terminal device is within the Bluetooth signal range of the first terminal device.

Optionally, the resource sharing module provided by the embodiments of the present disclosure, when sending the resource to be shared to the second terminal device, may be configured to:

acquire the internet protocol IP address information of the second terminal device,

determine whether the second terminal device and the first terminal device are located in the same WiFi environment according to the Internet protocol IP address information, and

send, in the WiFi communication mode, the resource to be shared to the second terminal device, when the second terminal device and the first terminal device are located in the same WiFi environment.

Optionally, the resource sharing module provided by the embodiments of the present disclosure, when sending the resource to be shared to the second terminal device, may be configured to:

acquire the internet protocol IP address information of the second terminal device;

determine whether the second terminal device is within the Bluetooth signal range of the first terminal device according to the Internet protocol IP address information, and

send, in the Bluetooth communication mode, the resource to be shared to the second terminal device, when the second terminal device is within the Bluetooth signal range of the first terminal device.

According to one or more embodiments of the present disclosure, a resource sharing apparatus is provided. The apparatus includes:

a sending request receiving module, configured to receive, in a short-distance communication mode, a sending request for a resource to be shared sent by a first user through a first terminal device, and display the sending request;

an operation instruction receiving module, configured to receive an operation instruction of a second user based on the sending request; wherein the first user and the second user are users using a same application;

an operation performing module, configured to perform a corresponding operation according to the operation instruction.

Optionally, in the case where the operation instruction includes acquiring the user information of the first user, the operation performing module provided by the embodiments of the present disclosure, when performing the corresponding operation according to the operation instruction, may be configured to:

send a user information request of the first user to the server,

receive the user information of the first user sent by the server based on the user information request of the first user, and

display the user information of the first user.

Optionally, in the case where the operation instruction includes acquiring the user information of a third user, the operation performing module provided by the embodiment of the present disclosure, when performing the corresponding operation according to the operation instruction, may be configured to:

send a user information acquiring request of the third user to the server,

receive the user information of the third user sent by the server based on the user information acquiring request of the third user, and

display the user information of the third user.

Optionally, in the case where the operation instruction includes acquiring the user information of the third user, the operation performing module provided by the embodiment of the present disclosure, when performing the corresponding operation according to the operation instruction, may further be configured to:

jump to and display a homepage of the third user.

The above descriptions are merely optional embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A resource sharing method, applied to a first terminal device, comprising:
acquiring user information of at least one candidate user; wherein the first terminal device searches, in a short-distance communication mode, a terminal device to which each candidate user belongs;
displaying the user information, and receiving a selecting operation of a first user for the user information;
determining a second user according to the selecting operation, and determining a device where the second user is located as a second terminal device; and
sending, in the short-distance communication mode, a resource to be shared to the second terminal device.

2. The method according to claim 1, wherein the determining the second user according to the selecting operation, comprises:
determining one and/or more candidate users as the second user according to the selecting operation.

3. The method according to claim 1, wherein the sending the resource to be shared to the second terminal device, comprises:
acquiring location information of the second terminal device;
determining whether the second terminal device is within a short-distance communication signal range of the first terminal device according to the location information; and
sending, in the short-distance communication mode, the resource to be shared to the second terminal device, when the second terminal device is within the short distance communication signal range of the first terminal device,
wherein the short-distance communication signal comprises a Bluetooth signal.

4. The method according to claim 1, wherein the sending the resource to be shared to the second terminal device, comprises:
acquiring internet protocol IP address information of the second terminal device;
determining whether the second terminal device and the first terminal device are located in a same WiFi environment according to the internet protocol IP address information; and
sending, in a WiFi communication mode, the resource to be shared to the second terminal device, when the second terminal device and the first terminal device are located in the same WiFi environment.

5. The method according to claim 1, wherein the sending the resource to be shared to the second terminal device, comprises:
acquiring internet protocol IP address information of the second terminal device;
determining whether the second terminal device is within a Bluetooth signal range of the first terminal device according to the internet protocol IP address information; and
sending, in a Bluetooth communication mode, the resource to be shared to the second terminal device, when the second terminal device is within the Bluetooth signal range of the first terminal device.

6. A resource sharing method, applied to a second terminal device, comprising:
receiving, in a short-distance communication mode, a sending request for a resource to be shared sent by a first user through a first terminal device, and displaying the sending request;
receiving an operation instruction of a second user based on the sending request; wherein the first user and the second user are users using a same application;
performing a corresponding operation according to the operation instruction.

7. The method according to claim 6, wherein the operation instruction comprises acquiring user information of the first user, and the performing the corresponding operation according to the operation instruction, comprises:
sending a user information acquiring request for the first user to a server;
receiving the user information of the first user sent by the server based on the user information acquiring request for the first user; and
displaying the user information of the first user.

8. The method according to claim 6, wherein the operation instruction comprises acquiring user information of a third user, the third user is a user who uploads the resource to be shared to the application, and the performing the corresponding operation according to the operation instruction, comprises:
sending a user information acquiring request for the third user to a server;
receiving the user information of the third user sent by the server based on the user information acquiring request for the third user; and
displaying the user information of the third user.

9. The method according to claim 8, wherein the displaying the user information of the third user, comprises:
jumping to and displaying a homepage of the third user.

10. A resource sharing apparatus, comprising:
a user information acquiring module, configured to acquire user information of at least one candidate user; wherein a first terminal device searches, in a short-distance communication mode, a terminal device to which each candidate user belongs;
a selecting operation receiving module, configured to display the user information, and receive a selecting operation of a first user for the user information;
a second terminal device determining module, configured to determine a second user according to the selecting operation, and determine a device where the second user is located as a second terminal device;
a resource sharing module, configured to send, in the short-distance communication mode, a resource to be shared to the second terminal device.

11. A resource sharing apparatus, comprising:
a sending request receiving module, configured to receive, in a short-distance communication mode, a sending request for a resource to be shared sent by a first user through a first terminal device, and display the sending request;
an operation instruction receiving module, configured to receive an operation instruction of a second user based on the sending request; wherein the first user and the second user are users using a same application;
an operation performing module, configured to perform a corresponding operation according to the operation instruction.

12. An electronic device, comprising:
one or more processors;
a memory;
one or more applications, wherein the one or more applications are stored in the memory and configured to be executed by the one or more processors; and the one or more applications are configured to: execute the resource sharing method according to claim 1.

13. A non-volatile computer-readable medium storing at least one instruction, at least one program, a code set or an instruction set, wherein the at least one instruction, the at least one program, the code set or the instruction set is loaded and executed by the processor to implement the resource sharing method according to claim 1.

14. The method according to claim 2, wherein the sending the resource to be shared to the second terminal device, comprises:
acquiring location information of the second terminal device;
determining whether the second terminal device is within a short-distance communication signal range of the first terminal device according to the location information; and
sending, in the short-distance communication mode, the resource to be shared to the second terminal device, when the second terminal device is within the short distance communication signal range of the first terminal device,
wherein the short-distance communication signal comprises a Bluetooth signal.

15. The method according to claim 2, wherein the sending the resource to be shared to the second terminal device, comprises:
acquiring internet protocol IP address information of the second terminal device;
determining whether the second terminal device and the first terminal device are located in a same WiFi environment according to the internet protocol IP address information; and
sending, in a WiFi communication mode, the resource to be shared to the second terminal device, when the second terminal device and the first terminal device are located in the same WiFi environment.

16. The method according to claim 2, wherein the sending the resource to be shared to the second terminal device, comprises:
acquiring internet protocol IP address information of the second terminal device;
determining whether the second terminal device is within a Bluetooth signal range of the first terminal device according to the internet protocol IP address information; and
sending, in a Bluetooth communication mode, the resource to be shared to the second terminal device, when the second terminal device is within the Bluetooth signal range of the first terminal device.

17. The method according to claim 3, wherein the sending the resource to be shared to the second terminal device, comprises:
acquiring internet protocol IP address information of the second terminal device;
determining whether the second terminal device and the first terminal device are located in a same WiFi environment according to the internet protocol IP address information; and
sending, in a WiFi communication mode, the resource to be shared to the second terminal device, when the second terminal device and the first terminal device are located in the same WiFi environment.

18. The method according to claim 3, wherein the sending the resource to be shared to the second terminal device, comprises:
acquiring internet protocol IP address information of the second terminal device;
determining whether the second terminal device is within a Bluetooth signal range of the first terminal device according to the internet protocol IP address information; and
sending, in a Bluetooth communication mode, the resource to be shared to the second terminal device, when the second terminal device is within the Bluetooth signal range of the first terminal device.

19. An electronic device, comprising:
one or more processors;
a memory;
one or more applications, wherein the one or more applications are stored in the memory and configured to be executed by the one or more processors; and the one or more applications are configured to: execute the resource sharing method according to claim 6.

20. A non-volatile computer-readable medium storing at least one instruction, at least one program, a code set or an instruction set, wherein the at least one instruction, the at least one program, the code set or the instruction set is loaded and executed by the processor to implement the resource sharing method according to claim 6.
